(19) United States
(12) Patent Application Publication
(10) Pub. No.: US 2024/0123879 A1
(43) Pub. Date: Apr. 18, 2024

(54) TAILGATE SEAT FOR A VEHICLE

(71) Applicant: Jose Villarreal, Corpus Christi, TX (US)

(72) Inventor: Jose Villarreal, Corpus Christi, TX (US)

(21) Appl. No.: 17/964,354

(22) Filed: Oct. 12, 2022

(51) Int. Cl. B60N 2/30

(52) U.S. Cl. CPC B60N 2/3095

(57) ABSTRACT

A tailgate seat, including a seat portion to receive buttocks of a user thereon, a back portion movably disposed on at least a portion of the seat portion to receive a back of the user thereon, and a base disposed on at least a portion of the back portion to removably connect to at least a portion of a vehicle.

### BACKGROUND

### 1. Field

The present general inventive concept relates generally to a seat, and particularly, to a tailgate seat for a vehicle.

### 2. Description of the Related Art

Generally, a tailgate refers to a board or gate at a rear part of a vehicle, such as a truck, a wagon, and/or a station wagon. Moreover, tailgating is a social activity involving people holding a party and/or a social gathering from the tailgate of the vehicle. Typically, people will have food and/or drinks while socializing around the tailgate of the vehicle.

However, anyone participating in the tailgating activity will often experience long uncomfortable hours sitting on the tailgate of the vehicle, whether camping, fishing, attending a sporting event, and/or a host of other activities. Although sitting on the tailgate is a common practice, it is neither ideal nor comfortable for any extended period of time.

Therefore, there is a need for a tailgate seat that can be connected to the tailgate to improve comfort and support while sitting.

### SUMMARY

The present general inventive concept provides a tailgate seat for a vehicle.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tailgate seat, including a seat portion to receive buttocks of a user thereon, a back portion movably disposed on at least a portion of the seat portion to receive a back of the user thereon, and a base disposed on at least a portion of the back portion to removably connect to at least a portion of a vehicle.

The base may connect between a tailgate and a bed of the vehicle.

The tailgate seat may further include a plurality of extension rods disposed on at least a portion of a first side of the back portion and a first side of the base, and disposed on a second side of the back portion and a second side of the base opposite with respect to the first side.

The plurality of extension rods may include a first extension rod movably disposed at a first end on at least a portion of the back portion and movably disposed at a second end on at least a portion of the base, and a second extension rod movably disposed at a first end on at least a portion of the back portion and movably disposed at a second end on at least a portion of the base.

The back portion may include a first rod receiving channel disposed on an edge thereof and recessed with respect to the edge to receive at least one of the first extension rod and the second extension rod therein.

The base may include a second rod receiving channel disposed on an edge thereof and recessed with respect to the edge to receive at least one of the first extension rod and the second extension rod therein.

The back portion may move from retracted against the base in a first position to at least partially extended away from the base in a second position, and moves from extended away from the base in the second position to retracted against the base in the first position.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a side perspective view of a tailgate seat for a vehicle in a retracted position, according to an exemplary embodiment of the present general inventive concept;

FIG. 1B illustrates a side perspective view of the tailgate seat for the vehicle in an extended position, according to an exemplary embodiment of the present general inventive concept; and

FIG. 2 illustrates a rear perspective view of the tailgate seat for the vehicle in a closed position, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Tailgate Seat 100
Seat Portion 110
Back Portion 120
First Rod Receiving Channel 121
Base 130
Second Rod Receiving Channel 131
Hinge 140
Extension Rods 150
First Extension Rod 151
Second Extension Rod 152
Base Connecting Fasteners 160

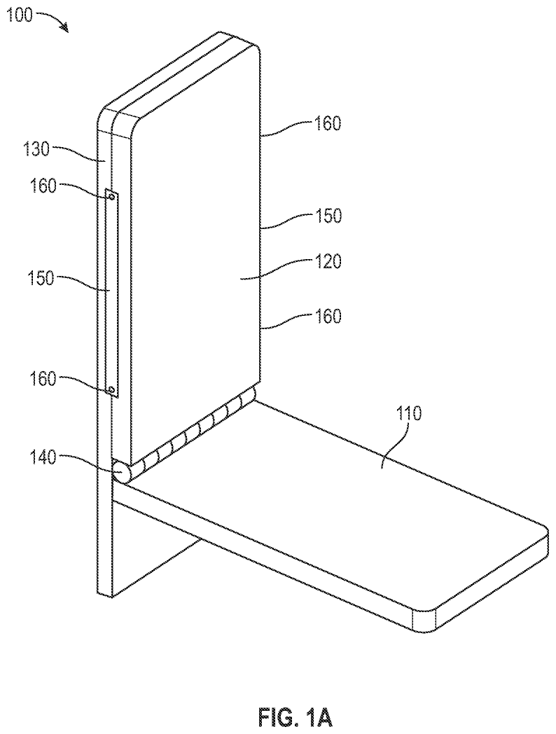

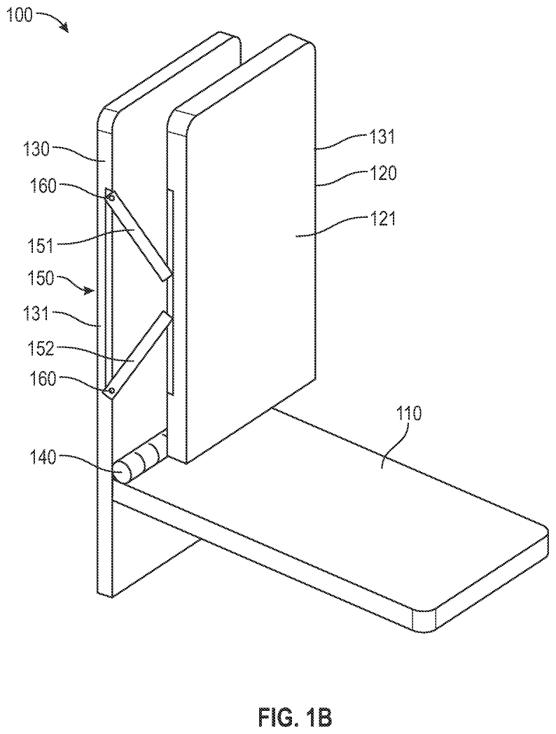

FIG. 1A illustrates a side perspective view of a tailgate seat 100 for a vehicle in a retracted position, according to an exemplary embodiment of the present general inventive concept.

FIG. 1B illustrates a side perspective view of the tailgate seat 100 for the vehicle in an extended position, according to an exemplary embodiment of the present general inventive concept.

The tailgate seat 100 may be constructed from at least one of metal, plastic, wood, and rubber, etc., but is not limited thereto.

The tailgate seat 100 may include a seat portion 110, a back portion 120, a base 130, a hinge 140, a plurality of extension rods 150, and a plurality of base connecting fasteners 160, but is not limited thereto.

The seat portion 110 and/or the back portion 120 may be constructed as a cushion, a foam, a pillow, a memory foam, and/or any combination thereof, but is not limited thereto.

The back portion 120 may include a first rod receiving channel 121, but is not limited thereto.

The seat portion 110 may be movably disposed on at least a portion of the back portion 120. In other words, the seat portion 110 and/or the back portion 120 may fold with respect to each other. Moreover, the seat portion 110 may receive a user thereon. For example, the seat portion 110 may receive buttocks of the user thereon. Also, the seat portion 110 may absorb an application force thereto.

Similarly, the back portion 120 may receive the user thereon. For example, the seat portion 110 may allow the user to sit, and the back portion 120 may support a back of the user. Also, the back portion 120 may absorb an application force thereto.

The base 130 may include a second rod receiving channel 131, but is not limited thereto.

The base 130 may be more rigid with respect to the seat portion 110 and/or the back portion 120. The base 130 may be disposed on at least a portion of the back portion 120. The base 130 may support the back portion 120 thereon. Additionally, the base 130 may have a size (e.g., length, width) greater than a size (e.g., length, width) of the back portion 120.

Furthermore, an end of the base may be removably connected to a vehicle, such as between a tailgate and a bed of a pick-up truck. As such, the user may sit on the seat portion 110 and/or the back portion 120 to improve comfort while using the tailgate. It is important to note that the base 130 may be specifically designed and constructed to fit within the tailgate and the bed of the pick-up truck based on a type of the pick-up truck.

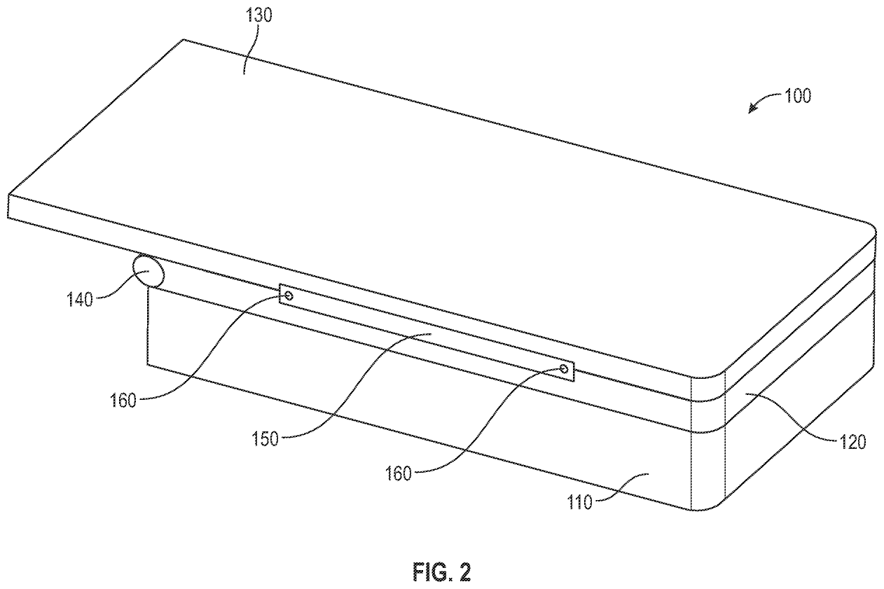

FIG. 2 illustrates a rear perspective view of the tailgate seat 100 for the vehicle in a closed position, according to an exemplary embodiment of the present general inventive concept.

The hinge 140 may be movably (i.e., rotatably, pivotally) disposed on at least a portion of the seat portion 110 and/or the back portion 120. In other words, the hinge 140 may be disposed between the seat portion 110 and/or the back portion 120. As such, the seat portion 110 and/or the back portion 120 may move with respect to each other via the hinge 140.

Therefore, referring to FIGS. 1A and 2, the seat portion 110 and/or the back portion 120 may move from opened in a first position to closed (i.e., folded) in a second position. Conversely, the seat portion 110 and/or the back portion 120 may move from closed in the second position to at least partially opened in the first position. As such, the seat portion 110 and/or the back portion 120 may be closed for storage.

Each of the plurality of extension rods 150 may include a first extension rod 151 and a second extension rod 152, but is not limited thereto.

The plurality of extension rods 150 may be disposed on at least a portion of a first side of the back portion 120 and/or a first side of the base 130, and a second side of the back portion 120 and/or a second side of the base 130 opposite with respect to the first side.

The first extension rod 151 may be movably (i.e., rotatably, pivotally) disposed at a first end on at least a portion of the back portion 120 and movably (i.e., rotatably, pivotally) disposed at a second end on at least a portion of the base 130. More specifically, the first extension rod 151 may be disposed within the first rod receiving channel 121 and/or the second rod receiving channel 131.

Moreover, the first rod receiving channel 121 may be recessed with respect to an edge of the back portion 120 where the first rod receiving channel 121 is disposed. Similarly, the second rod receiving channel 131 may be recessed with respect to an edge of the base 130 where the second rod receiving channel 131 is disposed.

The second extension rod 152 may be movably (i.e., rotatably, pivotally) disposed at a first end on at least a portion of the back portion 120 and movably (i.e., rotatably, pivotally) disposed at a second end on at least a portion of the base 130. More specifically, the second extension rod 152 may be disposed within the first rod receiving channel 121 and/or the second rod receiving channel 131.

It is important to note that the aforementioned description of the plurality of extension rods 150, the first rod receiving channel 121, and/or the second rod receiving channel 131 may be applied to the first side and/or the second side of the back portion 120 and/or the base 130.

During use, referring to FIGS. 1A and 1B, the back portion 120 may move from retracted against the base 130 in a first position to at least partially extended away from the base 130 in a second position. Conversely, the back portion 120 may move from extended away from the base 130 in the second position to retracted against the base 130 in the first position. Accordingly, a position and/or a size (e.g., distance from the seat portion 110) of the back portion 120 may be adjusted based on a preference of the user.

While the back portion 120 moves with respect to the base 130, the plurality of extension rods 150 may move from retracted within the first rod receiving channel 121 and/or the second rod receiving channel 131 to at least partially extended away from the first rod receiving channel 121 and/or the second rod receiving channel 131. Conversely, the plurality of extension rods 150 may move from extended away from the first rod receiving channel 121 and/or the second rod receiving channel 131 to retracted within the first rod receiving channel 121 and/or the second rod receiving channel 131. Furthermore, the first extension rod 151 may be angularly disposed differently from the second extension rod 152 while both are extended.

Each of the plurality of base connecting fasteners 160 may include a pin, a screw, a nail, and a bolt, but is not limited thereto.

The plurality of base connecting fasteners 160 may connect the plurality of extension rods 150 to the base 130. Also, the plurality of base connecting fasteners 160 may facilitate movement of the plurality of extension rods 150 with respect to the base 150.

Therefore, the tailgate seat 100 may improve comfort of the user and provide support while using the tailgate of the vehicle. Also, the tailgate seat 100 may be easily adjusted for comfort of the user.

The present general inventive concept may include a tailgate seat 100, including a seat portion 110 to receive buttocks of a user thereon, a back portion 120 movably disposed on at least a portion of the seat portion 110 to receive a back of the user thereon, and a base 130 disposed on at least a portion of the back portion 120 to removably connect to at least a portion of a vehicle.

The base 130 may connect between a tailgate and a bed of the vehicle.

The tailgate seat 100 may further include a plurality of extension rods 150 disposed on at least a portion of a first side of the back portion 120 and a first side of the base 130, and disposed on a second side of the back portion 120 and a second side of the base 130 opposite with respect to the first side.

The plurality of extension rods 150 may include a first extension rod 151 movably disposed at a first end on at least a portion of the back portion 120 and movably disposed at a second end on at least a portion of the base 130, and a second extension rod 152 movably disposed at a first end on at least a portion of the back portion 120 and movably disposed at a second end on at least a portion of the base 130.

The back portion 120 may include a first rod receiving channel 121 disposed on an edge thereof and recessed with respect to the edge to receive at least one of the first extension rod 151 and the second extension rod 152 therein.

The base 130 may include a second rod receiving channel 131 disposed on an edge thereof and recessed with respect to the edge to receive at least one of the first extension rod 151 and the second extension rod 152 therein.

The back portion 120 may move from retracted against the base 130 in a first position to at least partially extended away from the base 130 in a second position, and moves from extended away from the base 130 in the second position to retracted against the base 130 in the first position.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tailgate seat, comprising:
a seat portion to receive buttocks of a user thereon;
a back portion movably disposed on at least a portion of the seat portion to receive a back of the user thereon; and
a base disposed on at least a portion of the back portion to removably connect to at least a portion of a vehicle.

2. The tailgate seat of claim 1, wherein the base connects between a tailgate and a bed of the vehicle.

3. The tailgate seat of claim 1, further comprising:
a plurality of extension rods disposed on at least a portion of a first side of the back portion and a first side of the base, and disposed on a second side of the back portion and a second side of the base opposite with respect to the first side.

4. The tailgate seat of claim 3, wherein the plurality of extension rods comprises:
a first extension rod movably disposed at a first end on at least a portion of the back portion and movably disposed at a second end on at least a portion of the base; and
a second extension rod movably disposed at a first end on at least a portion of the back portion and movably disposed at a second end on at least a portion of the base.

5. The tailgate seat of claim 4, wherein the back portion comprises:
a first rod receiving channel disposed on an edge thereof and recessed with respect to the edge to receive at least one of the first extension rod and the second extension rod therein.

6. The tailgate seat of claim 4, wherein the base comprises:
a second rod receiving channel disposed on an edge thereof and recessed with respect to the edge to receive at least one of the first extension rod and the second extension rod therein.

7. The tailgate seat of claim 1, wherein the back portion moves from retracted against the base in a first position to at least partially extended away from the base in a second position, and moves from extended away from the base in the second position to retracted against the base in the first position.
